(19) United States
(12) Patent Application Publication
(10) Pub. No.: US 2026/0063429 A1
(43) Pub. Date: Mar. 5, 2026

(54) METHOD AND APPLICATION FOR FORMING A CUSTOMIZED ELECTRONIC MAP FOR OPTIMIZING A REAL TIME ROUTE IN OUTDOOR AND INDOOR ENVIRONMENTS

(71) Applicant: Citynomadi Oy, Tampere (FI)

(72) Inventors: Sami KARHUMÄKI, Tampere (FI); Merja TAIPALEENMÄKI, Tampere (FI)

(21) Appl. No.: 19/105,189

(22) PCT Filed: Aug. 18, 2023
(86) PCT No.: PCT/FI2023/050479

§ 371 Date: Feb. 20, 2025

(30) Foreign Application Priority Data
Aug. 22, 2022 (FI) 20227113

(51) Int. Cl. G01C 21/34; G01C 21/00

(52) U.S. Cl. CPC G01C 21/3423; G01C 21/3453; G01C 21/383

(57) ABSTRACT

The invention relates to a method for forming or modifying a customized electronic map of a combined electronic map for an optimized way finding application. The method comprises receiving a floor plan or plans of different floors of a facility or a ground plan of an outdoor area in electronic form, forming movement paths from a plurality of points to a plurality of points for forming a movement path network, adding movement information to the floor plan or the floor plans or the ground plan, and adding additional information to the floor plan or the floor plans or the ground plan. The invention further relates to an electronic device and a computer program product performing the method. In addition, the invention also relates to a method for optimizing a route in a combined electronic map comprising an electronic outdoor and a customized electronic indoor or outdoor map by an optimized way finding application and an electronic device and a computer program product performing the method.

### TECHNICAL FIELD

The examples and non-limiting embodiments relate generally to a customized electronic map creating a method and an apparatus to carry out the map creating finding method and to an optimized way finding application, an optimized way finding method, and an optimized way finding computer program product causing an apparatus to carry out the optimized way finding method, which optimized way finding application causes defining an optimized route for a user in the created customized map comprising outdoor and indoor environments or a combination thereof.

### BACKGROUND

In some areas street addresses or other guidance methods are incomplete or limited or they do not even exist. Users may have difficulty finding their destination especially in those areas even when using an electronic map or following the physical sign post applications. Examples of those kinds of areas are, for example, indoor areas of buildings and groups of buildings, for example, facilities, hospitals and shopping centers, and their outdoor areas, but also parks and various event areas such as festival areas, events, traffic hubs, green areas, industrial and logistic sites, circular economy sites, and campus areas.

Technologies such as Global Positioning System (GPS)-enabled devices and map applications have made outdoor way finding more convenient and accurate, but there are still difficulties in areas without street addresses and in wide and busy business sites. Whereas, indoor positioning with GPS offers the whereabout of the user, and does not offer the exact destination within the building, which is often more important.

Guidance in areas with no thorough or detailed address or other guidance information may have been taking care of, for example, with physical signs or maps of areas, digital signages or map images on websites. However, these methods are prone to different interpretations, are not interactive, and do not take into account different needs of users that move in the area, such as employees, distribution traffic, customers or people with mobility or other accessibility issues. In addition, updating of physical sign information can be slow or difficult when the environment or conditions change, for example in the case of road work, renovation or other exceptional situations. Undetailed guidance causes stress, unnecessary searching of destinations, driving around and thus useless traffic emission and noise.

### SUMMARY

Now there has been invented an improved method and technical equipment implementing the method. Various aspects of the invention include a method, an apparatus and a computer readable medium comprising a computer program stored therein, which are characterized by what is stated in the independent claims. Various embodiments of the invention are disclosed in the dependent claims.

A computer implemented method for forming or modifying a customized electronic map of a combined electronic map for an optimized way finding application comprises receiving a floor plan or floor plans of different floors of a facility or a ground plan of an outdoor area, forming movement paths from a plurality of points to a plurality of points for forming a movement path network to the floor plan or floor plans or the ground plan, adding movement information to the floor plan or floor plans or the ground plan, and adding additional information to the floor plan or floor plans or the ground plan.

The method may further comprise adding or removing one or more movement paths or parts of one or more movement paths. An electronic device is configured to perform the method. The device is an electronic computing device, such as a computer, laptop, mobile device, smart phone, tablet computer.

A computer implemented method for optimizing a route in a combined electronic map comprising an electronic outdoor map and a customized electronic indoor map or a customized electronic outdoor map by an optimized way finding application comprises receiving a starting point for the route, if not using a location application for defining the starting point or if the starting point is not predetermined by a weblink or a machine readable code used for opening the optimized way finding application, receiving a destination of a user, if not predetermined by a weblink or a machine readable code used for opening the optimized way finding application, optimizing the route to the destination from the starting point, and displaying the route on the map, wherein the route continues from outdoor environment into and inside a facility of the customized electronic indoor map or from outdoor environment to and inside an area without street addresses of the customized electronic outdoor map.

The optimizing of the route comprises selecting the route, for example, so that the moving time is minimum or the moving distance is shortest taking into account at least one of the following criteria: the user group of the user, a day, a time of a day, a season of the year, a special need information, or a way of moving. The information of the user group of the user, the special need or the way of moving is received from the user, if not predefined by the weblink or the machine readable code. The route optimizing method may further comprise displaying the route as a list of written instructions comprising at least one of the following information: moving direction, length of time to move to a certain direction, or length of moving to a certain direction for a certain part of the route or the whole route. The certain part of the route is a part of the route between two point-of interests, which a point of interest is, for example, a crossroad, a point of turn, a tunnel, a bridge, a door, stairs, an elevator, or a gate. A first user group can have different access rights than a second user group so that different routes are optimized for the first user group than the second user group. The user group can be one of the following: a regular user, an employee, a performer, a security person, an owner of the indoor environments, or maintenance. The way of moving can be a heavy vehicle, a car, public transportation, a bike, an electronic scooter, or walking. The map can comprise information of a time table and public transportation to be used in the route if public transportation is selected as the way of moving, and if they exist in the route. The optimized route can comprise information of a need to change a floor, use of lifts, and a point of a turn in the facility, if they exist in the route. An electronic device is configured to perform the method. The device is an electronic computing device, such as a computer, laptop, mobile device, smart phone, tablet computer. A computer program product embodied on a non-transitory computer readable medium, the computer program product comprising computer instructions that, when executed on at least one processor of a system or an apparatus, is configured to perform the route optimizing method.

### BRIEF DESCRIPTION OF THE DRAWINGS

In the following, various embodiments of the invention will be described in more detail with reference to the appended drawings, in which

FIG. 1a shows an example of a combined electronic map with an optimized route;

FIG. 1b shows an example of the customized outdoor environment map of the combined electronic map of FIG. 1a with the optimized route;

FIG. 1c shows an example of the customized indoor environment map of the combined electronic map of FIG. 1a with the optimized route;

FIG. 1d shows an example of a part of the customized indoor environment map of FIG. 1c with the optimized route; and

FIG. 2 shows an example of a display view of a customized electronic map forming software tool for forming and modifying a second floor view of a customized electronic indoor map of a facility;

FIGS. 3a-d show examples of display views of an optimized way finding application.

FIG. 4 shows an example of a method for forming or modifying a customized electronic map of a combined electronic map for an optimized way finding application, and

FIG. 5 shows an example of a method for optimizing a route in a combined electronic map comprising an electronic outdoor map and a customized electronic indoor map or a customized electronic outdoor map by an optimized way finding application.

### DETAILED DESCRIPTION

In the present invention different kinds of electronic maps i.e. electronic indoor maps of facilities, electronic outdoor maps and/or electronic customized outdoor maps can be combined as a combined electronic map. An optimized route can be, for example, defined by an optimized way finding method and displayed in a combined electronic map comprising an electronic indoor map of a facility and an electronic outdoor map, when a starting point is outdoor and the destination is a place inside the facility or vice versa. Thus, an optimized way finding application and method of the present invention enable finding of an optimized route for different users, for example, continuing from an indoor environment to an outdoor environment or vice versa and display the optimized route in a combined electronic map. In this context, the term “facility” covers all kinds of indoor environments such as buildings, building groups, shopping centers, university campuses, hospitals, etc. and may thus refer to any indoor space. The purpose of a combined electronic map is primarily to show for a user a route between his/her current location (or other defined location) and another object in relation to the environment in the real world. The optimized way finding application creates the optimized route that is a quality corridor within outdoors and indoors seamlessly. The quality corridor will be optimised according to the user's choice of a number of destinations within a site. The destination array may be located both outdoors and indoors in different floors, also underground. The destinations must be pointed out with the Wayfinding WebTuner tool being an electronic map forming software tool or automatically from the property data base. The Wayfinding WebTuner shows each site such as each floor as a unique entity. They i.e. electronic indoor maps, electronic outdoor maps and/or customized electronic outdoor maps are connected through the gates, ports, building entrances, stairs and elevator entrances which operate as points of interests as well.

Electronic indoor maps are in this context customized electronic indoor maps, which are formed on a floor plan or floor plans of different floors of a facility. These electronic indoor maps may also be called just as indoor maps or customized indoor maps. Electronic indoor maps are arranged to comprise information of movement paths inside the facility from a plurality of points of the facility to a plurality of points of the facility i.e. movement paths form a network of movement paths inside the facility. Information of each movement path comprises a route from one point to another and possible information of a change of floor including information which means is configured to be used for changing the floor. When a route is shown to a user on a display, the user gets all the necessary information to get from a first place of the facility to second place of the facility, which the user is searching for. The route may also comprise information relating to a moving direction, the length of time to walk to the second place, or the length of the distance to walk to the second place or the length of walk of a certain part of the route. The certain part of the route is a part of the route between points-of interest. A point of interest is a place inside a facility, for example, a point of turn, an elevator, an escalator, a door, an outdoor or any other definable object inside the facility and on the route. In addition, electronic indoor maps may further comprise additional information such as landmarks in the facility. Landmarks are, for example, common geometry objects in the facility, toilets, statues, restaurants or text etc., which may be indicated/shown to the user when the route is shown in the map and which may help to follow the route.

Points of interest and the connections i.e. path parts between them creates a network, and the orientation from a starting point to the destination on site optimizes the wayfinding process.

A combined electronic map may comprise at least one existing outdoor map comprising, for example, road optimized guidance information i.e. way finding information in outdoor environments such as GEO-API or Google Maps, and in addition or instead of the at least one existing outdoor map at least one customized electronic outdoor map. A customized electronic outdoor map is a base map of an area, for example, around a facility, a park, an industrial site or port etc, or any other area, which does not comprise accurate street address information or street address information at all or other guidance in the existing outdoor electronic maps. Customized electronic outdoor maps are arranged to comprise movement paths of the area from a plurality of points to a plurality of points. Movement paths are defined on the base map of the area and they create a network of movement paths in the area. Customized electronic outdoor maps may further comprise additional information such as information of an entrance port, an exit port, and landmarks, for example, common geometry objects in the area, a bike rack, a parking lot, toilets, restaurants, text, the nearest free parking zone, but also status of the parking lot or any other information in the area not only giving additional information but easing way finding and following a route in that area without street information or other adequate guidance. And, for example, a customized electronic outdoor map of e.g. a logistic center of the new cars may comprise information about locations of the logistic ID, which makes finding a route to the exact row and column and the height of the ID of the item at the site significantly easier, for example, from a gate of the logistic site, when the route can be searched for by the ID of the item. The electronic outdoor maps may also be called just as outdoor maps and electronic customized outdoor maps may also be called just as customized outdoor maps. A customized electronic map as a term covers both a customized electronic indoor map and a customized electronic outdoor map.

Wayfinding Web Tuner is thus an example of a customized electronic map forming software tool that enables forming i.e. structuring and modifying customized electronic indoor and customized electronic outdoor maps. In a case of, for example, a customized electronic indoor map a floor plan or floor plans of different floors of a facility are provided to be used in the software. The facility and its floor plan/plans are arranged i.e. positioned in its/their real world place in the outdoor map by the software. The movement paths are formed inside the facility from a plurality of points of the facility to a plurality of points of the facility for forming a network of movement paths inside the facility by the software or by using the features of the software. Movement paths are arranged to include lifts and escalators if comprising any. Additional information i.e. metadata is entered for the route such as, for example, a front door. So that when a user searches for a route to a place inside the facility, for example, from a railway station, the optimized way finding method can define the optimized route in an outdoor map of a combined electronic map first directly to the front door of the facility, which front door is defined by the metadata of the customized electronic indoor map as a place, wherefrom the route continuing from outdoor map is defined to start inside the facility, and further continue from the front door into the facility and to the searched place inside the facility using the customized electronic indoor map.

As for another example, in a case of searching for a route from the same railway station to the same place inside the facility, wherein the combined electronic map comprises the above mentioned electronic outdoor map, the above mentioned customized electronic indoor map, but also a customized electronic outdoor map. The customized electronic outdoor map is also formed using, for example, the Wayfinding Web Tuner as the customized electronic map providing software. The ground plan of the area around the facility are provided to be used in the software and it is arranged i.e. positioned in its/their real world place in the outdoor map by the software. The movement paths are formed to the area around the facility from a plurality of points of the area to a plurality of points of the area for forming a network of movement paths to the area around the facility by the software or by using the features of the software. Additional information i.e. metadata is again entered for the movement paths such as, for example, a parking lot or a bike rack. So that when the user searches the route to the place inside the facility from the railway station, for example, by a car, the optimized way finding method can define the optimized route in the outdoor map first directly to the parking lot (that is a starting point of routes in the customized electronic outdoor map when a car is used), the route continues in the customized electronic outdoor map from the parking lot to the front door, which front door was, as already mentioned defined by the metadata of the customized electronic indoor map as a starting place, wherefrom the route continues into the facility and further to the searched place inside the facility. Alternatively, when a user searches for a route to the same place inside the facility from the railway station by a bike, the optimized way finding method defines the optimized route first to the bike rack that is defined as a starting point of routes in the customized electronic outdoor map when a bike is used. From the bike rack the optimized route continues to the front door in the customized electronic outdoor map, which front door is again the starting place, wherefrom the route continues in the customized electronic indoor map into the facility and to the searched place inside the facility.

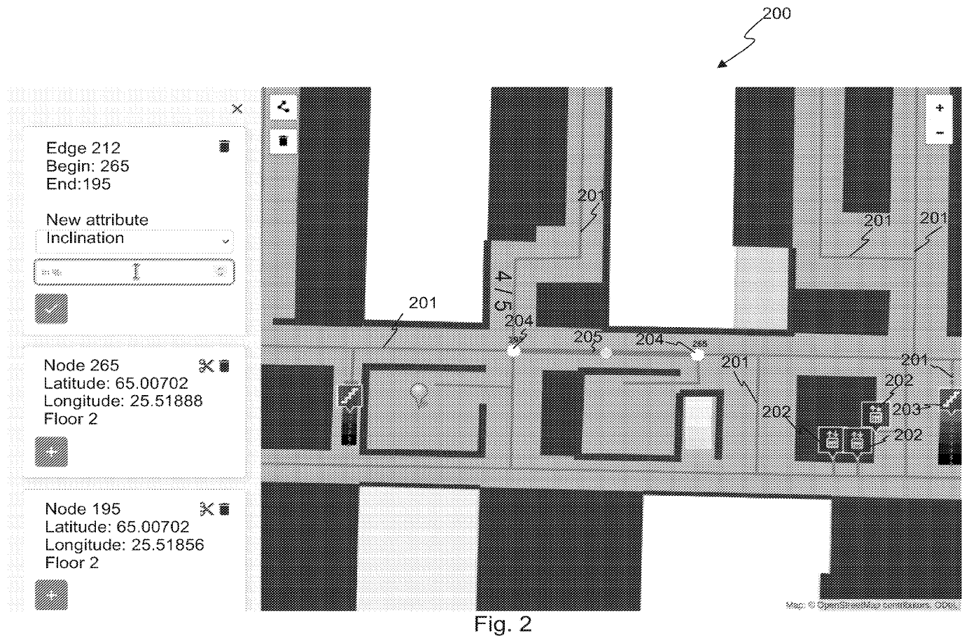

By the Wayfinding Web Tuner software it is also possible to define access rights of movement paths or parts of the moving paths (for example, between certain nodes or for certain edges, see FIG. 2) for different user groups so that when a user searches for an optimized route, his/hers user group is taken into account when the route is defined i.e. which routes are allowable for which user groups. Furthermore, it is possible to define time slots of movement paths or parts of the moving paths (for example, between certain nodes or for certain edges, see FIG. 2) when they are usable or not usable, for example, at different days, at different times of a day, and at different seasons of the year. In addition, by the Wayfinding Web Tuner software it is also possible, to define which movement paths or parts of the moving paths (for example, between certain nodes or for certain edges, see FIG. 2) are suitable for people with special need or for which movement paths or parts of the moving paths are suitable for which ways of moving. This kind of defining can be called by a collective name of movement information.

By the Wayfinding Web Tuner software, it is also easy to modify customized electronic indoor and outdoor maps so that new movement paths can be easily arranged and old movement paths can be easily changed in a case of a need to move the route to go somewhere else than earlier, for any reason. This way the optimized route is always liable and real time.

Other possible information in electronic outdoor maps or customized electronic outdoor maps may be, for example, information received from traffic and road condition databases, which contain very detailed information, for example, of heavy traffic, public transport information providing public transport schedules, lines and stop information, or weather information. Customized electronic outdoor maps may be, for example, information of human flows, parking garages, the status of city bike racks or the commercial e-scooters etc., which information of can be imported through the measurement of IoT sensors. The information may additionally be any other information that may be useful for optimizing a route to a destination. The information can be arranged to update at predetermined intervals or at times when the information to be shown changes. And, for example, API information feed can be arranged to update automatically regularly.

To search an optimized route a user opens an optimized way finding application utilizing a combined electronic map by opening an optimized way finding application, or by selecting a weblink or reading a machine readable code used for opening the optimized way finding application in a web browser. The user types a starting point for the route, if a location application defining the starting point is not in use or if the used weblink or used machine readable code does not define the starting point. Then the user types a destination for the route, if the used weblink or the used machine readable code does not define the destination. The user group of the user may be defined for the optimized way finding application by users themselves i.e. user himself or herself, but it may also be defined by the used weblink or the used machine readable code or the user group may be a basic user by default. The user may also have other possible selections to be made before a route is optimized and displayed. After these selections an optimized route is defined and displayed for the user in a combined electronic map comprising at least one electronic indoor map, at least one electronic outdoor map and at least one electronic customized outdoor map, or at least one electronic indoor map and at least one electronic outdoor map, or at least one electronic indoor map and at least one electronic customized outdoor map, or at least one electronic outdoor map and at least one electronic customized outdoor map. But in some cases, an optimized route can be defined and displayed just in an electronic indoor map of a facility instead of a combined electronic map.

There may be defined different movement paths for different user groups both in electronic indoor environment maps and in electronic customized outdoor maps. This is because different user groups may have different access right to different parts of a facility or an area or different moving capabilities. For example, different user groups may have different access rights in the facility or the area defined based on their relationship to the facility or the area, for example, owners and security personnel may have rights to go everywhere i.e. full access rights and a regular customer or a passer-by may have very limited access rights. Whereas, employees or delivering personnel may have access rights between the full right and limited access rights. In addition, as above mentioned there may be defined different movement paths for special need persons, for example, people with reduced mobility. In other words, this different movement paths for different user groups means that a first user group has different access rights than a second user group so that different movement paths i.e. routes are optimized for the first user group than second user group by the optimized way finding application. A user group may be defined, for example, as follows: a regular user, an employee, a security person, an owner of the indoor environments, or a performer, but it is not restricted to those, but any other user groups may defined and different optimized routes may be defined for each of them or a part of them.

In addition to different movement paths for different user groups, there may be different movement paths for different times of a day, days or seasons of a year. This can be due to, for example, a rush hour or the fact that certain ways, paths, roads or corridors etc. are closed, for example, for the night or for example, for the winter. In addition to different movement paths for different user groups or times, there may be different movement paths for different moving ways i.e. for a car, a heavy vehicle, a public transportation, a bike, an electronic scooter, or walking.

The route is optimized so that it is a shortest i.e. minimum moving length or a fastest i.e. minimum moving time to move from a first location to a second location taking into account i.e. considering at least one of the following criteria: a user group of a user, access rights, day, time of a day or a year and a way of moving defined for the optimized way finding application. This optimized route can be called as a way finding quality corridor. More than one optimized route can be suggested for selection for a user.

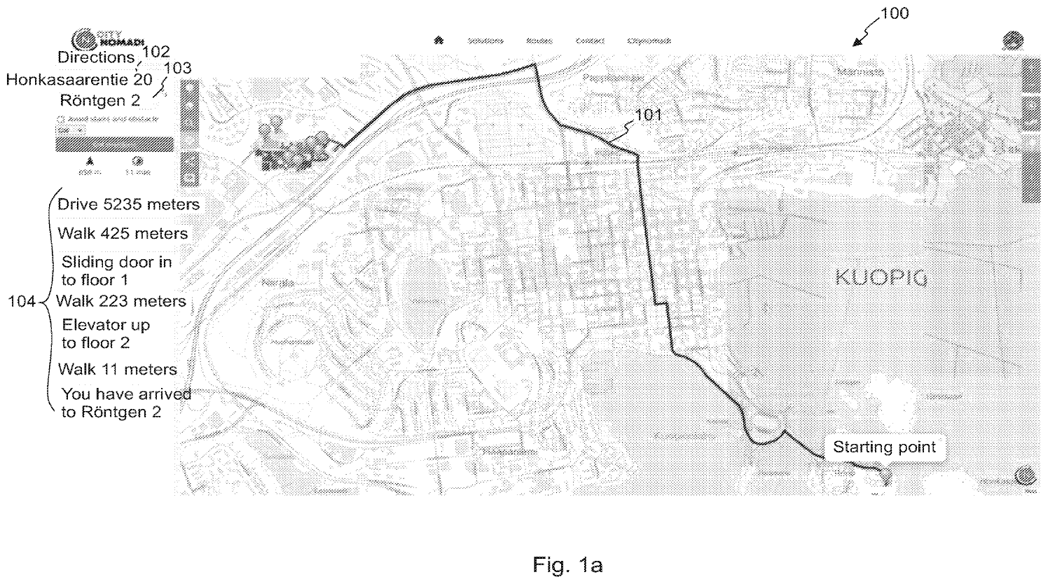

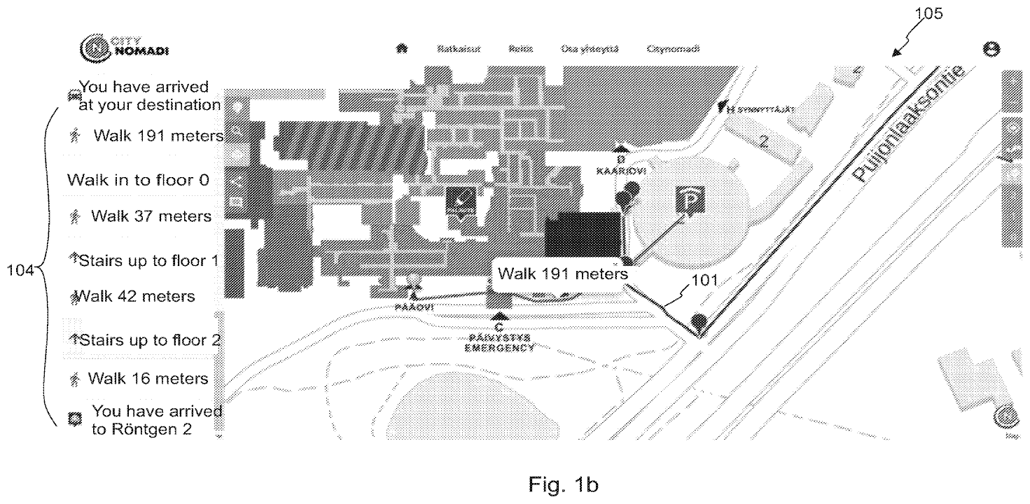

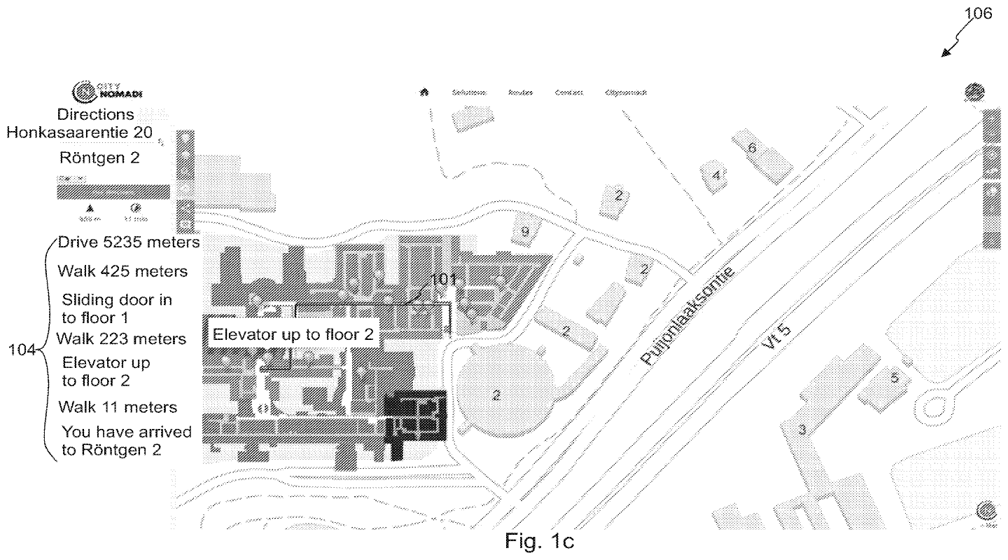

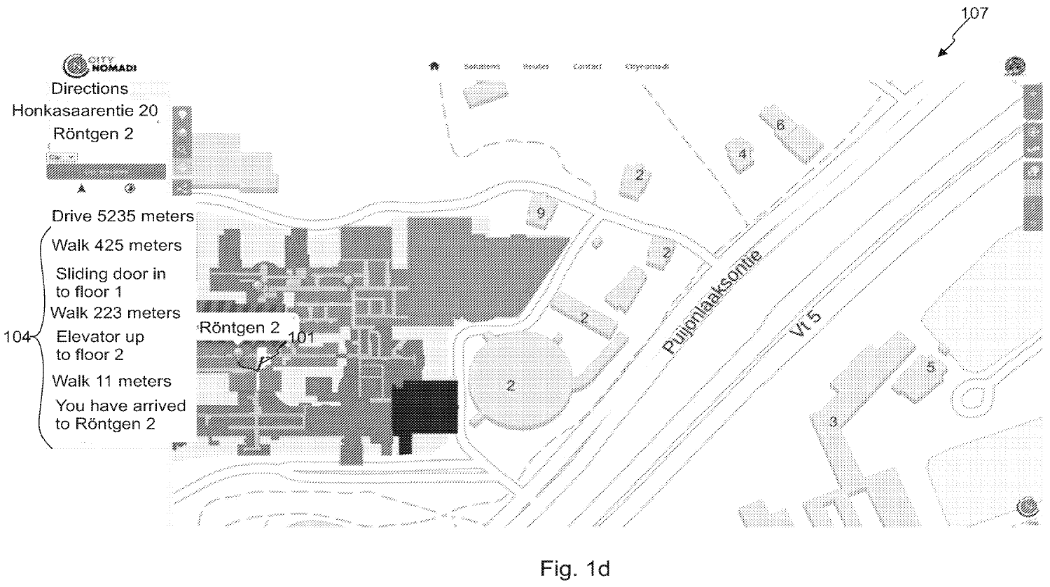

FIG. 1a shows an example of a combined electronic map 100 with an optimized route 101. A starting point 102 is in this example Honkasaarenranta and the destination 103 is x-ray (röntgen) of the local hospital facility, University hospital of Kuopio. The FIG. 1 shows the optimized route 101 i.e. the way finding quality corridor as it appears and it is displayed to a user as a whole from the starting point 102 to the destination 103. The combined electronic map 100 comprises an electronic outdoor environment map, a customized electronic outdoor map (shown in FIG. 1b) and an electronic indoor map (shown in FIG. 1c) that is customized as well. Those maps are connected as an integrated map covering both outdoor and indoor environments seamlessly. It should be noted that along the optimized route 101, the user travels within the area of the customized electronic map by means of light transport i.e. by walking, by electric scooter etc. and by walking in the area of the electronic indoor environment map i.e. inside the hospital. The route 101 combines and connects different movement options (car and walking) as the optimized route from the starting point 102 to the destination 103 continues from outside environment to inside facility of the local hospital. The written instructions 104 of the optimized route 101 are also shown to ease following of the route 101. The written instructions 104 comprises instructions for moving by car and for walking in the area around the hospital shown by the customized outdoor map part and inside the hospital.

FIG. 1b shows an example of the customized outdoor environment map 105 that is a part of the combined electronic map 100 of FIG. 1a with the optimized route 101. The customized outdoor environment map 105 shows the phase of the optimized route 101 where the user changes the mode of transport from the car to walking. This is a step from the electronic outdoor map to the customized electronic outdoor map, and the owner of the property i.e. area around the hospital is able to produce/provide detailed guidance to the customized outdoor environment map 105 so that the optimized route continues through that area smoothly even if there are no street addresses. The customized outdoor environment map 105 can be modified or updated so that the optimized route 101 changes in it, if needed, for example, due to a roadwork.

FIG. 1c shows an example of the customized indoor environment map 106 of a first floor of the hospital that is a part of the combined electronic map 100 of FIG. 1a with the optimized route 101. The customized outdoor indoor environment map 106 shows the optimized route 101 in the interior of the hospital in floor 1. The optimized route 101 continues between different floors, the changing place of floors 108 from floor 1 to floor 2 is indicated, in this example, by text, but it may as well be indicated by an elevator icon or by an icon of stairs or an escalator. When the user selects, for example, by clicking the changing place of floors 108, the view of the indoor environment map 106 changes to second floor shown in FIG. 1d. The customized indoor environment map 106 can be modified so that the optimized route 101 changes in it, if needed, for example, due to a renovation.

FIG. 1d shows an example of a part of the customized indoor environment map 106 part of FIG. 1c with the optimized route 101. The part 107 of the customized indoor environment map 106 shows the optimized route 101 in the second floor within the hospital.

Existing way finding applications and methods, when searching the way to the destination 103 i.e. x-ray from Honkasaarenranta, would stop the route and guidance at the edge of the hospital area. But the solution of the present invention enables guidance seamlessly from starting point 102 Honkasaarenranta to the destination 103 x-ray through outdoor and indoor environments.

FIG. 2 shows an example of a display view of a customized electronic map forming software tool for forming and modifying a second floor 200 of a customized electronic indoor map of a facility. A floor plan of the second floor is provided for the software tool. In the second floor view 200 there are shown a plurality of movement paths 201 formed to the second floor and constructing a network of movement paths in the second floor of the facility. Movement paths 201 start from, end at, or continue through nodes 204. Nodes 204 correspond crossroads and are places where movement paths may 201 branch. The part of a movement path between nodes 204 may be called as an edge 205. An optimized route defined by an optimized way finding application starts from a first node 204, continue through from zero to a plurality of nodes 204 and end to the last node 204. In the second floor view 200 also elevator icons 202 and stairs icon 203 are shown as places to change floors from the second floor to upper floors or lower floors as additional information. If there is a need to modify a movement path 201 for some reason, one or more edges 205 or one or more nodes 204 may, for example, be removed from the view 200 of the customized electronic indoor map. So that when a user searches an optimized route inside the facility, the optimized route will not continue through those removed edges 205 or nodes 204. Alternatively, one or more edges 205 or one or more nodes 204 may, for example, be added to the view 200 of the customized electronic indoor map. So that when a user searches an optimized route inside the facility, the optimized route may be optimized to continue through those added edges 205 or nodes 204 if they are such that moving time of the optimized route will be minimum or the moving distance of the optimized route will be shortest taking into account at least one of the following criteria: the user group of the user, a day, a time of day, a season of the year, a special need information, or a way of moving.

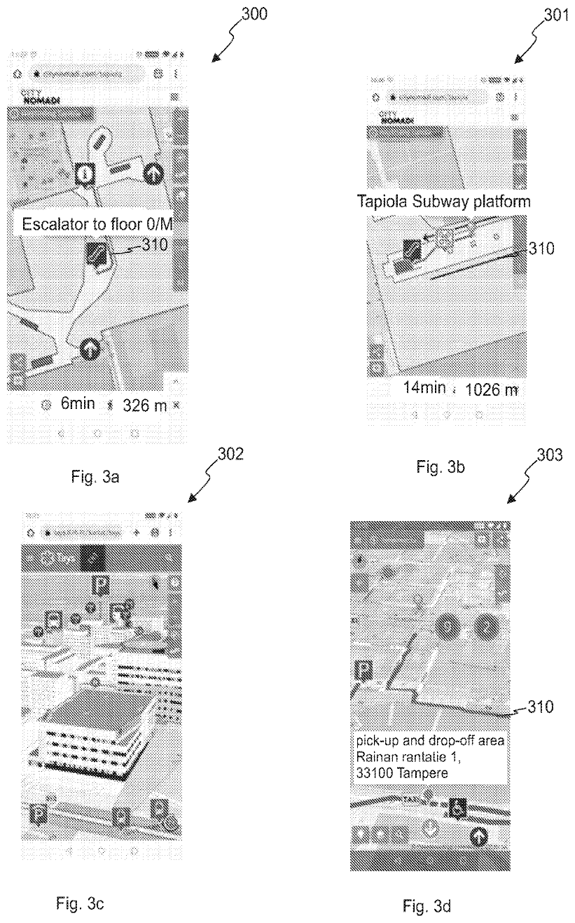

FIGS. 3a-3d show examples of display views of an optimized way finding application. FIG. 3a shows a display view 300 with an optimized route 310. FIG. 3b shows a display view 301 with an optimized route 310. FIG. 3c show a display view 302 without an optimized route. FIG. 3d shows a display view 303 with an optimized route 310.

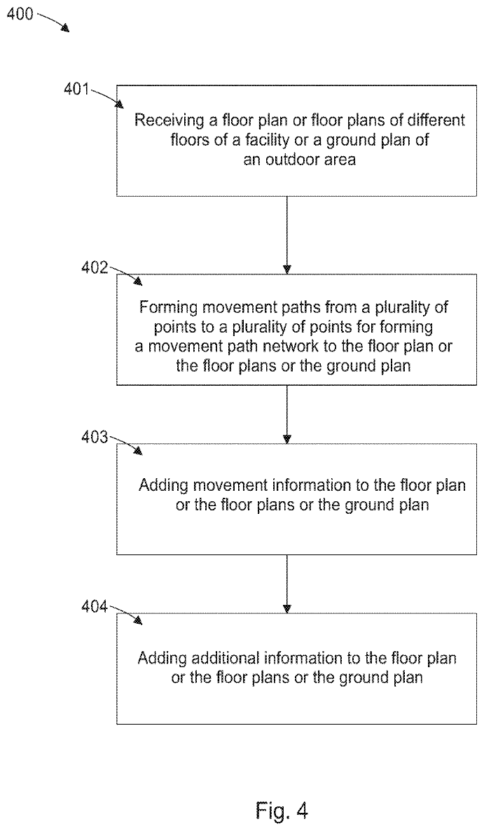

FIG. 4 shows an example of a computer implemented method 400 for forming or modifying a customized electronic map of a combined electronic map for an optimized way finding application. In step 401, a floor plan or floor plans of different floors of a facility or a ground plan of an outdoor area is received in electronic form. In step 402, movement paths from a plurality of points to a plurality of points for forming a movement path network to the floor plan or the floor plans or the ground plan is formed. In step 403, movement information to the floor plan or the floor plans or the ground plan are added. In step 404, additional information to the floor plan or the floor plans or the ground plan is added.

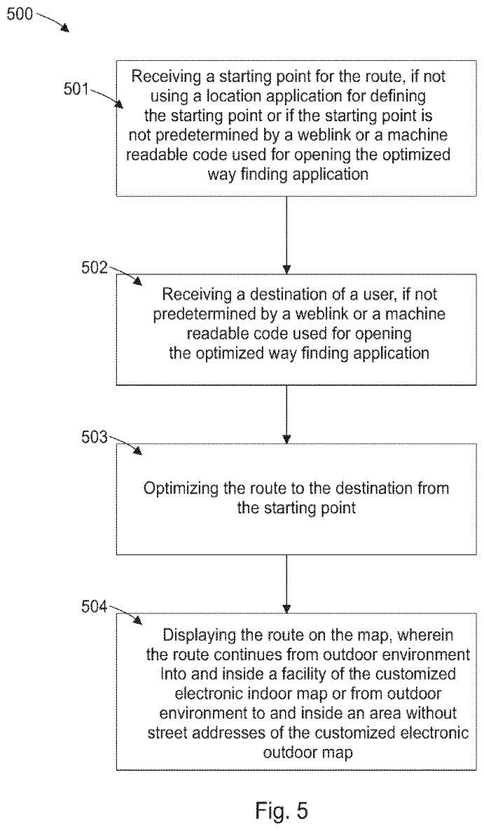

FIG. 5 shows an example of a computer implemented method 500 for optimizing a route in a combined electronic map comprising an electronic outdoor map and a customized electronic indoor map or a customized electronic outdoor map by an optimized way finding application. In step 501, a starting point for the route is received, if not using a location application for defining the starting point or if the starting point is not predetermined by a weblink or a machine readable code used for opening the optimized way finding application. In step 502, a destination of a user is received, if not predetermined by a weblink or a machine readable code used for opening the optimized way finding application. The machine readable code may be, for example, a QR code. In step 503, the route to the destination from the starting point is optimized. In step 503, the route on the map is displayed, wherein the route continues from outdoor environment into and inside a facility of the customized electronic indoor map or from outdoor environment to and inside an area without street addresses of the customized electronic outdoor map. The route on the map is displayed on a display of an electronic device. The movement information comprises at least one of the following: access rights of user groups in the movement paths, access rights at different days, times of a day, or seasons of a year in the movement paths, accessibility of a special need persons in the movement paths, or suitability for different kind of ways of moving in the movement paths.

Customized indoor and outdoor environment maps of the present invention are easily adjustable and editable. Such a feature enables maintenance of real-time guidance in facilities and outdoor areas without street addresses. This is needed so that routes in the facility or those outdoor areas are UpToDate despite, for example, of construction work, broken pipes, security or bad weather conditions. Thus by the present invention guidance is accuracy and it is possible to control so that it is smooth even in exceptional situations and people can be directed to go where they are wanted to go, for example, by the owner of a facility or area without street addresses or, for example, by an event organizer of an area without street addresses. In addition, because due to an optimized way finding application people find directly to right places, it is a smart mobility development that reduces emissions, saves time and reduces energy consumption. The optimized way finding method and application is a software that may be offered as a SaaS service.

An optimized way finding application is usable as a specific application and as a web application. It may be used by a computer, a mobile phone, a tablet computer, pc or any other suitable device.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

1. A computer implemented method for forming or modifying a customized electronic map of a combined electronic map for an optimized way finding application, which the combined electronic map further comprises an electronic outdoor map, the method comprises
receiving a floor plan or floor plans of different floors of a facility or a ground plan of an outdoor area in electronic form,
forming movement paths from a plurality of points to a plurality of points for forming a movement path network to the floor plan or the floor plans or the ground plan,
adding movement information to the floor plan or the floor plans or the ground plan, and
adding additional information to the floor plan or the floor plans or the ground plan, wherein the additional information comprises a place, where a route in the combined electronic map is configured to be continued between the outdoor map and the customized electronic map, and wherein the route to be displayed is configured to continue from the outdoor map into and the customized electronic indoor map or from the customized electronic indoor map to the outdoor map.

2. A computer implemented method according to claim 1, wherein the movement information comprises at least one of the following: access rights of user groups in the movement paths, access rights at different days, times of a day, or seasons of a year in the movement paths, accessibility of a special need persons in the movement paths, or suitability for different kind of ways of moving in the movement paths.

3. A computer implemented method according to claim 1, wherein the method further comprises:
adding or removing one or more movement paths or parts of one or more movement paths.

4. An electronic device configured to perform the method according to claim 1.

5. A computer program product embodied on a non-transitory computer readable medium, the computer program product comprising computer instructions that, when executed on at least one processor of a system or an apparatus, is configured to perform the method according to claim 1.

6. A computer implemented method for optimizing a route in a combined electronic map comprising an electronic outdoor map and a customized electronic indoor map or a customized electronic outdoor map by an optimized way finding application, and which the combined electronic map comprises additional information comprising a place, where a route in the combined electronic map is configured to be continued between the outdoor map and the customized electronic map, the method comprises:
receiving a starting point for the route, if not using a location application for defining the starting point or if the starting point is not predetermined by a weblink or a machine readable code used for opening the optimized way finding application;
receiving a destination of a user, if not predetermined by a weblink or a machine readable code used for opening the optimized way finding application;
optimizing the route to the destination from the starting point; and
displaying the route on the map, wherein the route continues from outdoor environment into and inside a facility of the customized electronic indoor map or from outdoor environment to and inside an area without street addresses of the customized electronic outdoor map through the place defined in the additional information.

7. A computer implemented method according to claim 6, wherein the optimizing of the route comprises selecting the route so that the moving time is minimum or the moving distance is shortest taking into account at least one of the following criteria: the user group of the user, a day, a time of a day, a season of the year, a special need information, or a way of moving.

8. A computer implemented method according to claim 7, wherein the information of the user group of the user, the special need or the way of moving is received from the user, if not predefined by the weblink or the machine readable code.

9. A computer implemented method according to claim 6, wherein the method further comprises:
displaying the route as a list of written instructions comprising at least one of the following information: moving direction, length of time to move to a certain direction, or length of moving to a certain direction for a certain part of the route or the whole route.

10. A computer implemented method according to claim 7, wherein the certain part of the route is a part of the route between two points-of interest, which a point of interest is a crossroad, a point of turn, a tunnel, a bridge, a door, stairs, an elevator, or a gate.

11. A computer implemented method according to claim 7,
wherein
a first user group has different access rights than a second user group so that different routes are optimized for the first user group than the second user group.

12. A computer implemented method according to claim 7,
wherein
the user group is one of the following: a regular user, an employee, a performer, a security person, an owner of the indoor environments, or maintenance.

13. A computer implemented method according to claim 7,
wherein
the way of moving is a heavy vehicle, a car, public transportation, a bike, an electronic scooter, or walking.

14. A computer implemented method according to claim 6,
wherein
the map comprises information of a time table and public transportation to be used in the route if public transportation is selected as the way of moving, and if they exist in the route.

15. A computer implemented method according to claim 6, wherein the route comprises information of a need to change a floor, use of lifts, and a point of a turn in the facility, if they exist in the route.

16. An electronic device configured to perform the method according to claim 6.

17. A computer program product embodied on a non-transitory computer readable medium, the computer program product comprising computer instructions that, when executed on at least one processor of a system or an apparatus, is configured to perform the method according to claim 6.
